(19) United States
(12) Patent Application Publication
(10) Pub. No.: US 2015/0066561 A1
(43) Pub. Date: Mar. 5, 2015

(54) VEHICLE YARD PLANNER SYSTEM AND METHOD

(71) Applicant: GENERAL ELECTRIC COMPANY, Schenectady, NY (US)

(72) Inventors: Mitchell Scott Wills, Melbourne, FL (US); SRINIVAS BOLLAPRAGADA, Niskayuna, NY (US); Jian LI, Melbourne, FL (US); Patrick Scorer, Melbourne, FL (US); Brian Francis Zustovich, Melbourne, FL (US); Keith Walter Lewandowski, Melbourne, FL (US); David Dylan Lennon, Melbourne, FL (US); Bryan Leigh Schofield, Melbourne, FL (US); Trevor Fletcher, Melbourne, FL (US); Xingang Cheng, Atlanta, GA (US); Xin Zhang, Duluth, GA (US); Yi-Tzer Lin, Atlanta, GA (US); Rajesh Kalra, Atlanta, GA (US); Xiaoou Zhang, Atlanta, GA (US)

(21) Appl. No.: 14/472,936

(22) Filed: Aug. 29, 2014

Related U.S. Application Data
(60) Provisional application No. 61/871,704, filed on Aug. 29, 2013.
(60) Provisional application No. 61/871,681, filed on Aug. 29, 2013.

(51) Int. Cl. G06Q 10/06

(52) U.S. Cl. CPC G06Q 10/06313; G06Q 10/06393; G06Q 10/06314
USPC 705/7.23

(57) ABSTRACT

A system and method includes receiving yard data at a yard planner system from a plurality of workstations and a plurality of sensors within a vehicle yard, wherein the yard data includes information regarding movement of vehicles and resources in relation to the vehicle yard. The system and method may also include using the yard planner system to form an initial yard plan based on the yard data, monitoring the yard data over time with the yard planner system, and updating the initial yard plan to form an updated yard plan based on changing yard data over time.

### CROSS-REFERENCE TO RELATED APPLICATIONS

The present application claims priority to U.S. Provisional Patent Application No. 61/871,704, entitled “Vehicle Yard Planner System and Method,” filed Aug. 29, 2013, which is hereby expressly incorporated by reference in its entirety.

The present application also claims priority to U.S. Provisional Patent Application No. 61/871,681, entitled “System and Method for Visually Presenting a Vehicle Yard,” filed Aug. 29, 2013, which is also hereby expressly incorporated by reference in its entirety.

### FIELD

Embodiments of the present disclosure generally relate to vehicle yard planner systems and methods.

### BACKGROUND

Various different vehicles may be positioned within a vehicle yard, such as a rail yard. The vehicles, such as train consists, may be moved between different locations within the vehicle yard. Various processing operations may be performed, either concurrently or serially, on the vehicles. In a typical rail yard, for example, inbound vehicle consists arrive at various times, outbound consists depart at various times, and the like. Due to the large amount of activity in the rail yards, it may be difficult for human operators at the yards to understand and plan for current and/or scheduled locations and operations being performed on the different vehicles. Further, operators may not be fully informed about the status of approaching vehicles or plans for recombination and preparation for outbound vehicles.

Some known planning systems may visually present the status of various vehicles by displaying different vehicles in different colors. The different colors may represent different status or stages in the processing of the vehicles. However, known systems may not provide a user with an easy way of seeing current locations of the vehicles, scheduled future locations of the vehicles, scheduled durations, sequences, and/or times of upcoming processing operations, and/or the like. As a result, the user may be unaware of the current and scheduled future state of the vehicle yard, as well as the prospective status of resulting outbound vehicles.

Accordingly, it may be difficult to efficiently distribute and schedule vehicle processing resources in a typical vehicle yard. As a result, dwell times of idle vehicles in the rail yard may increase, resulting in incoming and outgoing delays, diminished connection performance, and degraded on-time departure performance.

### BRIEF DESCRIPTION

Certain embodiments of the present disclosure provide a system that may include a vehicle yard planner system configured to receive data, such as yard data, from a plurality of workstations and a plurality of sensors within a vehicle yard. The yard data may include information regarding movement of vehicles and resources within the vehicle yard, and/or the progress of status transforming activities on the vehicles that have arrived or are approaching the vehicle yard. The vehicle yard planner system may be configured to form an initial yard plan based on the yard data. The vehicle yard planner system may also be configured to monitor the yard data over time and update the initial yard plan to form an updated yard plan based on changing yard data over time. The yard planer system may be configured to monitor the resources to determine availabilities of the resources and constraints on processing the vehicles.

The initial yard plan may include one or more initial schedules for moving the vehicles through the vehicle yard, and/or advancing the status of the vehicles through the vehicle yard. The updated yard plan may include one or more updated schedules for moving the vehicles through the vehicle yard, and/or advancing the status of the vehicles through the vehicle yard.

In at least one embodiment, the system may include a display device in communication with the yard planner system. The yard planner system may be configured to visually present a representation of the vehicle yard and the activities occurring within and approaching the vehicle yard on the display device, as well as activities related to preparing vehicles for departure.

The yard data may include yard state information that includes one or more of where the vehicles currently are located in the vehicle yard, where the vehicles are expected to be located in the vehicle yard at a future time, where the vehicle are approaching or planned to approach the yard, what operations are being performed on the vehicles, and what resources are being expended or used to perform the operations on the vehicles.

In at least one embodiment, the yard data may include yard goal information that includes when and where the vehicles are to be positioned when the vehicles exit the vehicle yard, and/or the egress route of the vehicles from the yard. The yard goal information may include vehicle connection goals that include designated tasks that are to be performed on the vehicles, wherein the tasks include cleaning, repair, maintenance, refueling, changing or crews, inspection, unloading of cargo, and loading of cargo while the vehicles are in the yard.

In at least one embodiment, the yard data may include performance information that indicates the efficiency of the vehicles moving into and through the vehicle yard. In at least one embodiment, the yard data may include administrative information that includes a current state of the yard planner system.

The yard information may include vehicle connection goals that designates an outbound vehicle consist that a first vehicle identified with the connection goal is to be included in when the first vehicle leaves the vehicle yard.

The yard planner system may include a monitor system that obtains the yard data as input information from one or more workstations and one or more sensors within or outside the vehicle yard. The workstation(s) may include one or more handheld or wearable devices. The sensor(s) may include one or more of transponders, video cameras, scanners, presence detectors, and track circuits configured to detect a presence of the vehicles at one or more locations in the vehicle yard.

The yard planner system may be configured to obtain the vehicle connection goals from a network planner system that creates schedules for the vehicles to travel through a network of routes that connect to the vehicle yard.

The yard planner system may include a bandwidth system that is configured to monitor constraints on processing operations that are performed on one or more of the vehicles within the vehicle yard. The bandwidth system may be configured to track route configurations in the vehicle yard. The route configurations may include a layout of routes on which the vehicles travel within the vehicle yard, and capacities of the routes within the vehicle yard. The bandwidth system may be configured to track one or both of vehicle inventories in the vehicle yard, and resource availabilities in the vehicle yard. The bandwidth system may be configured to track route maintenance within, approaching, or leading away from the vehicle yard. Also, the bandwidth system may be configured to track time requirements for the processing operations.

The yard planner system may include a generation system that is configured to plan movements of the vehicles through the vehicle yard, and processing activities to be performed on the vehicles. The yard planner system may be configured to optimize performance objectives, minimize or otherwise reduce resource requirements, maintain a desired level of orderliness of yard state, and/or the like.

The initial and updated yard plans may include information regarding one or more of: management of arrival of each inbound vehicle subject to capacity of the vehicle yard to receive the inbound vehicle, assignment of receiving segments of vehicle routes to each inbound vehicle (for example, an ingress route), one or more schedules of air bleeding and vehicle inspection activities at various locations in the vehicle yard, one or more schedules of a sequence of vehicles to move to a hump in the yard, assignment of each the vehicles to a classification route segment where the vehicles are sorted together in blocks for continued movements or operations in the vehicle yard, one or more schedules of a sequence of the vehicles to pull from classification route segments to departure route segments, assignment of outbound vehicles to departure segments (for example, an egress route), and one or more schedules of outbound inspection operations of the vehicles.

In at least one embodiment, the initial and updated yard plans are time-configurable in relation to a planning horizon.

The system may also include one or more workstations within the vehicle yard. Each of the workstations may be in communication with the yard planner system. Each workstation may include a tracking system that is configured to receive sensor data either directly or indirectly from sensors within or outside the vehicle yard. The tracking system is configured to determine one or more of: a location of at least one of the vehicles within the yard, or approaching (or planned to approach) the yard through the sensor data, a processing status of processing operations performed or planned to be performed on the at least one of the vehicles, and a state of at least one route segment within or outside the vehicle yard. Each workstation may include a planning system configured to receive the initial and updated yard plans from the yard planner system.

The yard planner system and/or the workstation(s) may include a display device that is configured to show a visual presentation of the vehicle yard, status, plan, and performance measures. The visual presentation may include a time bar that represents current and future times, and route lines for routes that are used to receive inbound vehicles, dispatch outbound vehicles, and/or move vehicles among yard processing stage. The visual presentation may also include processing operation symbols that denote processing operations that are one or both of being performed and are scheduled to be performed on the vehicles. The visual presentation may also include a timing line configured to represent one or both of when and how long one or more of the processing operations is expected to occur. The visual presentation may also include one or more status windows that are configured to indicate current status of various resources and inventory within, approaching, or planned to approach the vehicle yard.

In at least one embodiment, the vehicle yard planner system is configured to identify one or more opportunities for track maintenance within one or more idle times between planned activities. The vehicle yard planner system may be configured to reserve one or more yard resources, such as tracks, facilities, equipment, or the like, for the one or more opportunities.

Certain embodiments of the present disclosure provide a method that may include receiving data, such as yard data, at a yard planner system from a plurality of workstations and a plurality of sensors within or outside a vehicle yard. The yard data includes information regarding movement of vehicles and resources within the vehicle yard, approaching the vehicle yard, and/or planned to approach the vehicle yard. The method may also include using the yard planner system to form an initial yard plan based on the yard data, monitoring the yard data over time with the yard planner system, and updating the initial yard plan to form an updated yard plan based on changing yard data over time.

### BRIEF DESCRIPTION OF THE DRAWINGS

The subject matter described herein will be better understood from reading the following description of non-limiting embodiments, with reference to the attached drawings, wherein below:

FIG. 1 illustrates a schematic representation of a vehicle yard planner system, according to an embodiment of the present disclosure.

FIG. 2 illustrates a schematic representation of a vehicle yard planner system, according to an embodiment of the present disclosure.

FIG. 3 illustrates a schematic representation of a vehicle yard, according to an embodiment of the present disclosure.

FIG. 4 illustrates a schematic representation of a route network, according to an embodiment of the present disclosure.

FIG. 5 illustrates a schematic representation of a yard workstation, according to an embodiment of the present disclosure.

FIG. 6 illustrates a visual presentation of a vehicle yard as shown on a display device of a yard workstation, according to an embodiment of the present disclosure.

FIG. 7 illustrates a portion of a visual presentation of a vehicle yard as shown on a display device of a yard workstation, according to an embodiment of the present disclosure.

FIG. 8 illustrates a visual presentation of a vehicle yard as shown on a display device of a yard workstation, according to an embodiment of the present disclosure.

FIG. 9 illustrates a visual presentation of a vehicle yard as shown on a display device of a yard workstation, according to an embodiment of the present disclosure.

FIG. 10 illustrates a flow chart of a method of managing or planning a vehicle yard, according to an embodiment of the present disclosure.

### DETAILED DESCRIPTION

Certain embodiments of the present disclosure provide systems and methods for automatic scheduling of the processing of vehicles from inbound vehicle consists, through a vehicle yard, and into outbound vehicle consists. The schedules that are automatically generated may be referred to as yard plans or optimized plans that efficiently move the vehicles into, through, and out of the vehicle yard. The term “optimized” (and derivations thereof) is intended to refer to a more efficient schedule than may be achieved by human intelligence alone, due to the consequences of each decision. As such, an optimized schedule may or may not include the most efficient schedule. As an example, an optimized schedule may be the most efficient schedule, or a schedule that is more efficient than one or more other schedules, but not necessarily all other schedules. A yard plan may be used to receive vehicles from plural vehicle consists approaching or planned to approach a vehicle yard, separate the vehicles, process the vehicles (as described below), and re-assemble the vehicles into the same or different vehicle consists heading out of the vehicle yard in less time, with improved performance, using fewer resources, and with increased orderliness than any plans or ad-hoc approaches of known systems and methods. Embodiments of the present disclosure may monitor yard resource availabilities and constraints on processing vehicles in order to create the yard plans that schedule sequences of operations to process the different vehicles through the yard. Following the scheduled sequence of operations in the yard plans may move vehicles from inbound consists, through the yard, and into outbound consists faster and/or with consuming less resources of the vehicle yard than manually scheduling the operations and/or scheduling the operations without monitoring the resource availability and/or processing constraints.

The term “consist” refers to a combination of two or more vehicles that are mechanically coupled with each other to travel together along a route. A train is one example of a consist, but a consist of two or more other types of vehicles may also be used. The vehicles may include propulsion-generating vehicles (for example, vehicles capable of self-propulsion, such as locomotives, automobiles, airplanes, marine vessels, or the like) and non-propulsion-generating vehicles (for example, vehicles that are not capable of self-propulsion, such as rail cars, trailers, barges, or the like). While the description herein focuses on rail vehicles, not all embodiments are limited to rail vehicles. While the description herein may refer to the vehicle yard being a rail yard, the vehicle consists being rail vehicle consists or trains, and the vehicles being locomotives or rail cars, one or more embodiments of the systems and methods described herein also may be applied to other types of vehicles and vehicle yards, such as other off-highway vehicles (for example, vehicles that are not designed or permitted to travel on public roadways, such as mining equipment), automobiles, marine vessels (e.g., ships through a shipyard, port, or the like), aircraft (e.g., airplanes in an airport), autonomous vehicles, or the like.

Certain embodiments of the present disclosure provide a vehicle yard planner system that may be used to assist an operational staff of a vehicle yard by providing analytical support and producing movement and processing plans (for example, yard plans) for the vehicle yard. By integrating with existing management information systems and sensors inside and outside the vehicle yard, the vehicle yard planner system may be aware of the entire state, both current and prospective, of the vehicle yard at various or all points in time. The yard planner system may produce yard plans detailing optimal sequences of activities for the vehicle yard. Execution of such a yard plan drives efficiency with respect to overall yard operations, but may also reduce the length of time that a vehicle is idle (for example, not moving or being processed in the yard, referred to as dwell time) and may increase on-time departures of vehicle consists from the vehicle yard and may increase orderliness or yard operations. Certain embodiments of the present disclosure provide systems and methods that may automatically formulate a yard plan that prescribes operations to be performed on vehicles in order to more efficiently move the vehicles into, through, and out of the vehicle yard.

Certain embodiments of the present disclosure provide systems and methods for visually presenting a representation of a vehicle yard (such as a rail yard) and the activities occurring within the yard in a single, easily understood collection displays. Within a single display window, a user may identify a vast amount of information including yard resources, vehicle consists (for example, trains) approaching the yard, the vehicle consists scheduled to depart from the yard, the entire lifecycle of planned activities in order to meet outbound schedules of the vehicle consists, and the like. The visualization of the vehicle yard that is presented to the user may be time-based to permit the user to identify what activities are currently occurring, as well as looking into the future to see what activities are planned to occur within a user-controllable time period (referred to herein as a rolling planning horizon).

As shown and described herein, in at least one embodiment, the representation of route segments (for example, tracks) in the vehicle yard may be oriented vertically in order to provide a seamless view of the yard, with individual route segments within the yard, approaching the yard, leading away from the yard, clustered or grouped together by their function, such as receiving, classification, forwarding, and the like. Such organization allows for the display of the entire yard in a manner that is both intuitive and easily understood by the user.

Planned activities of the yard include those processing operations that are scheduled to be performed on one or more vehicles in the consists as they approach the yard to receive the vehicles into the yard, to move the vehicles through the yard (including performing maintenance, inspection, cleaning, loading/unloading of cargo, and the like), and to prepare the vehicles for departing the yard, such as by grouping the vehicles into outbound consists (which may not be the same consists in which the vehicles arrived into the yard). In the visual display that is provided to the user, the planned activities may be drawn horizontally on top of the route segments as a connection of an origin and destination route for the activity that is represented. This represents the movement of vehicles across the routes in a predominantly left-to-right flow through the yard. The origin of the planned activity may be represented by a first symbol (for example, a black diamond or other icon), while the destination may be represented by a different, second symbol (for example, a smaller grey diamond or other icon). This view provides the user with a singular reference to the entire yard in a logical progression of vehicle movements.

Additional information may be presented to the user through the use of visually presented planned activities, gadgets, or tools on the display device. Activities may be grouped by the type of activity and a data-rich container specific to a planned activity may be presented for viewing by the user. The user may expand and collapse each group of activities, as well as a specific activity, to allow the user to view only desired information, or to interrogate a planned activity for detailed information.

The entire view of the yard plan may be represented in relation to time, which may be displayed vertically or horizontally. This enables the user to easily identify the exact routes, resources, and vehicles that will be in use at any given point in the planning horizon. The planned activities are drawn according to the respective start and end times on a time graph, thereby allowing the user to not only visualize the sequence of the activities but also the duration of the activity.

To assist the user in understanding where the planning constraints are in the yard, a route that is blocked may be represented differently from other routes, such as by using a red line (or other drawing) on top of the affected route. Another type of line (e.g., a blue line) may represent a route that is still usable, but whose use is restricted relative to other routes (such as where the route is under maintenance but can still be accessed by the maintenance crew).

The consists that are approaching and/or departing from the yard may be displayed as a black bar (or other symbol) with identifying information unique to each consist being displayed within the bar or other symbol. Arriving consists may be displayed with a line to a receiving route, which may be a representation of the receiving route assignment and the beginning of the inbounding activities. Consists that do not have a receiving route assignment may not be displayed with the connection line, thereby alerting the user that an assignment may need to be made. Departing consists can be displayed based on the scheduled departure times of the consists. The connection of the forwarding route, pullback lead route, and/or classification route may aid in defining the consist building activities for the user. Given that these are all drawn in relation to time, the user may also be able to easily infer the time required to build the outbound route in order to meet the scheduled departure time of the consist.

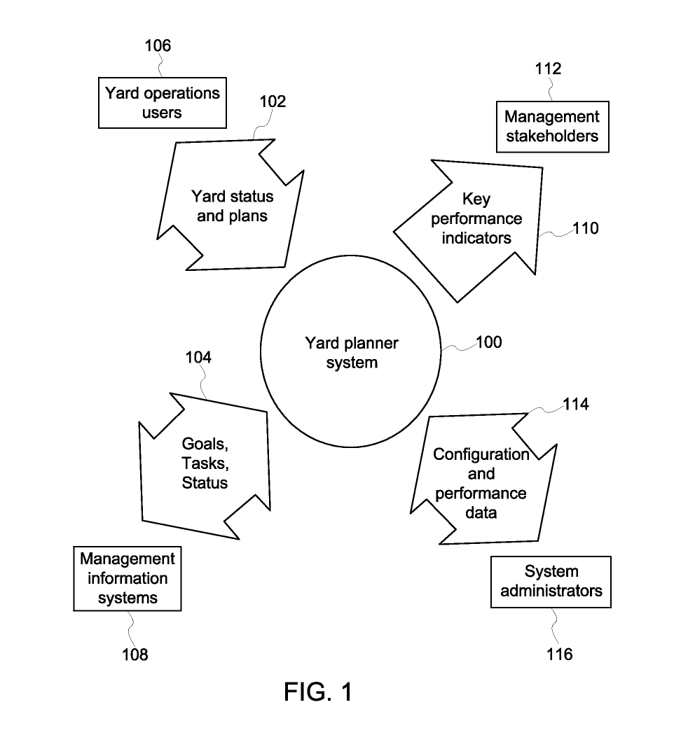

FIG. 1 illustrates a schematic representation of a vehicle yard management or planner system 100, according to an embodiment of the present disclosure. FIG. 1 illustrates various types of data/information that may be input to and/or output from the yard planner system 100, as well as the other systems or entities that may provide the input and/or receive the output. Yard state and/or plan data/information 102 (“Yard Status and Plans” in FIG. 1) may be communicated with yard operators and/or other users (collectively, operators 106). The yard state information indicates the status of the different vehicles in, approaching, and/or planned to approach the yard, such as where the vehicles currently are located, where the vehicles are expected (for example, scheduled) to be located, what operations are being performed or are planned to be performed on the vehicles, what resources (for example, equipment, tools, personnel, or the like) are being expended or used to perform the operations on the vehicles, and the like. The yard state information can be obtained by the yard planner system 100 through messaging (for example, peer-to-peer messaging) with management information systems, such as system-wide vehicle inventory management systems (that monitor which vehicles are in the yard and/or locations of the vehicles as the vehicles approach, move through and depart the yard), through direct data entry by the operators via a user interface.

Yard goals, tasks, and/or status data/information 104 (“Goals, Tasks, Status” in FIG. 1) may be communicated with management information systems 108 that monitor and/or track the vehicles in the yard. The goals may include information on where the vehicles are to be positioned when the vehicles exit the vehicle yard. For example, several vehicles on the same inbound vehicle consist heading into the vehicle yard may be scheduled to leave the yard on different outbound consists heading to different locations. The vehicle connection goals may indicate which consists the various vehicles are designated or scheduled to be included in when the vehicles leave the yard, and may include acceptable alternate consists that these vehicles may leave the yard in if the designated or scheduled consist is unavailable or the vehicles cannot be included in the designated or scheduled consists due to one or more constraints. A connection goal additionally or alternatively may indicate a departure time for the vehicle out of the yard. Getting the vehicle into a consist that leaves the yard no later than this departure time may achieve the connection goal.

The yard goal information 104 may include vehicle connection goals that may include designated operations (for example, tasks) that are to be performed on the different vehicles, such as cleaning, repair, maintenance, refueling, unloading of cargo, loading of cargo, or the like, while the vehicles are in the yard. The yard planner system 100 may automatically formulate the yard plans and communicate the yard plans or portions thereof to the operators. For example, the yard planner system 100 may send the entire yard plan to one or more operators, and/or may automatically generate and send work orders that implement the yard plan to the operators. The work orders may dictate when and where an operator is to perform a task designated by the work order on one or more vehicles in the yard. Performance of the work orders may result in the yard plan being implemented to move the vehicles through and out of the yard.

The yard workers may include tracking devices, such as contained with handheld devices, wearable devices, or workstations, that are configured to allow the yard worker to be tracked within the rail yard. Thus, if a task is to be performed on a particular vehicle, such as a car within a consist, the yard planner system 100 may track the position of the yard worker that is to perform the task (such as refueling, air bleeding of brakes, repair, cargo loading, etc.) and the time that the yard worker is at the particular vehicle. The yard planner system 100 may automatically determine whether or not a particular task was completed, such as through a time the yard worker was detected at a particular position. Optionally, the yard worker may input data regarding the task(s) through the handheld device. The yard planner system 100 may then receive the input data and/or task exception information and adjust or update a yard plan accordingly.

Performance data/information 110 (“Key Performance Indicators” in FIG. 1) may be communicated from the yard planner system 100 to stakeholders 112 (“Management Stakeholders” in FIG. 1), such as owners of the vehicles, consists, cargo being carried by the vehicles, or the like. The performance information may indicate how efficiently (for example, how quickly) vehicles are planned to approach, being accepted into, moved through, and out of the vehicle yard, how often the vehicles are being placed into the correct outbound consists, and the like. The yard planner system 100 monitors the yard state information 102 and vehicle connection goals 104, and may provide a comprehensive tactical picture to yard operations personnel 106 and to stakeholders 112 throughout the business. Administrative data/information 114 (“Configuration and Performance Data” in FIG. 1) may be communicated with system administrators 116, such as those persons that manage operations of the vehicle yard planning system. The administrative information may include the current state of the yard planner system 100, changes to the yard planner system 100, and/or at least some of the performance information. The yard planner system 100 may graphically display the duration of the scheduled and actual processing operations for the vehicles, as well as status of the processing occurring on the various routes in the yard. The yard planner system 100 may notify the user of the effect of other vehicle movements and processing activities which impact the flow (for example, movement) of one or more other vehicles through the yard.

The yard planner system 100 may form an initial yard or movement plan based on received and/or input yard data, which may include information regarding yard resources, vehicle consists approaching the vehicle yard, vehicle consists scheduled to depart the vehicle yard, and/or the like. The yard planner system 100 monitors the state of the yard through received and/or sensed information/data to update the yard plan. For example, the yard planner system 100 may update a yard plan based on received movement data (including information regarding inbound and outbound consists), activity information, yard state information, yard goal information, performance information, administrative information and/or the like. As can be appreciated, the initial yard plan may not be able to be fulfilled due to various delays or processing exceptions. The yard planner system 100 monitors the activities within the yard and updates the yard plan to adapt to changing circumstances.

The yard planner system 100 may support two or more modes of operation, such as an automated planning mode and/or a manual planning mode. In the automated planning mode, the yard planner system 100 may use the collected yard state information, for example, to automatically execute a planning algorithm to generate a yard-level processing plan that provides a detailed schedule, including time and resources, for the movement and processing of each vehicle through the yard during the planning horizon. As one example, the plan can schedule the primary flow of rail cars over a hump of the yard, through a bowl of the yard, and outbound on departing trains. In the manual planning mode, the yard state and yard goals, tasks, and/or status information 104 may be displayed to an authorized user who uses a graphical interface with the yard planner system to construct a plan for the processing and movement of one or more vehicles being handled by the yard.

Once a yard plan is generated, the operators 106 may work from the plan. The yard planner system 100 may automatically generate the work orders for the operators and/or other system level communication messages to support the back-end processing of the vehicle movements as planned.

As one example of a portion of a yard plan for a designated rail car, the yard plan may direct the designated rail car in an inbound train to be removed from the train on a first track within a first time period, taken to a cargo unloading area on a second connected track at a first designated time where the cargo is unloaded, taken to a third track to perform maintenance on the rail car (for example, cleaning, inspection, or the like) within a second time period, taken to a fourth track to load additional cargo into the rail car at a second designated time, and then taken to a fifth track to be included in another train for departure from the yard at a third designated time. Similar portions of the yard plan may be applicable to the operations to be performed on other rail cars. A combination of several or all rail cars being processed in the yard at a given time may be a yard plan.

The yard planning system 100 collects yard operations data (for example, “yard data”) from different locations within the vehicle yard. The yard operations data may include the yard state information, the yard goal information, the performance information, the administration information, and the like. The yard planning system 100 updates the yard plan based on the received operations data. The yard planning system 100 may constantly update the yard plan to create a new or updated yard plan in order to move vehicles out of the yard as quickly and efficiently as possible. The yard planning system 100 may update the yard plan based on numerous factors, such as vehicle movement, air bleeding of vehicles, powered status of vehicle, inspection activities, repair activities, cargo status, a presence of hazardous materials, track vacancy, and the like.

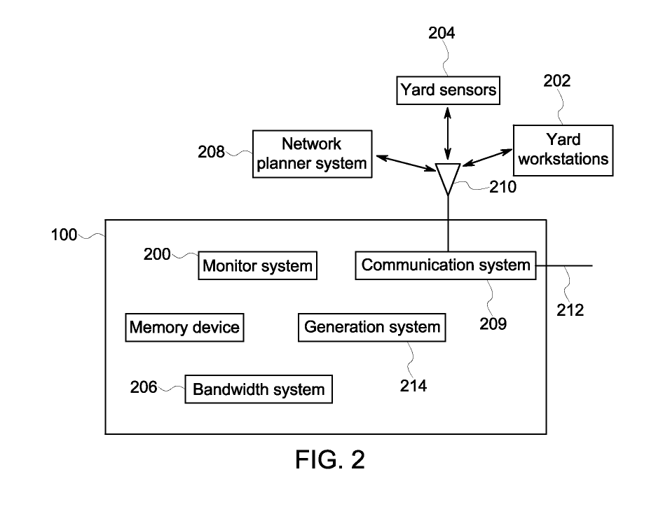

FIG. 2 illustrates a schematic representation of the vehicle yard planner system 100, according to an embodiment of the present disclosure. The yard planner system 100 may include several systems that perform various operations. The systems described herein (both included in the yard planner system 100 and external to the yard planner system 100) may include or represent hardware and associated instructions (for example, software stored on a tangible and non-transitory computer readable storage medium, such as a computer hard drive, solid state memory, ROM, RAM, or the like) that perform the operations described herein. The hardware may include electronic circuits that include and/or are connected to one or more logic-based devices, such as microprocessors, processors, controllers, or the like. These devices may be off-the-shelf devices that perform the operations described herein from the instructions described above. Additionally or alternatively, one or more of these devices may be hard-wired with logic circuits to perform these operations. Two or more of the systems may share one or more electronic circuits and/or logic-based devices. In one or more embodiments, the systems described herein may be understood as including or representing electronic processing circuitry such as one or more field programmable gate arrays (FPGA), application specific integrated circuits (ASIC), or microprocessors. The systems may be configured to execute one or more algorithms to perform functions described herein. The one or more algorithms may include aspects of embodiments disclosed herein, whether or not expressly identified in a flowchart or as a step or operation of a method.

In at least one embodiment, the yard planner system 100 may be or include a web-based (or other network based) system built upon Service Oriented Architecture (SOA) principles as several Java Enterprise Edition (EE) applications. The various applications may be responsible for providing a distinct facet of the overall planner system. The functions of the applications may be defined by a Web Services Definition Language (WSDL) interface that serves as a defined contract of interaction with the application. By separating the functionality across multiple applications, or components, the different responsibilities of the applications (for example, systems) may be segregated or separated from each other. For example, a task that is outside of the responsibility of one system may be delegated to another system.

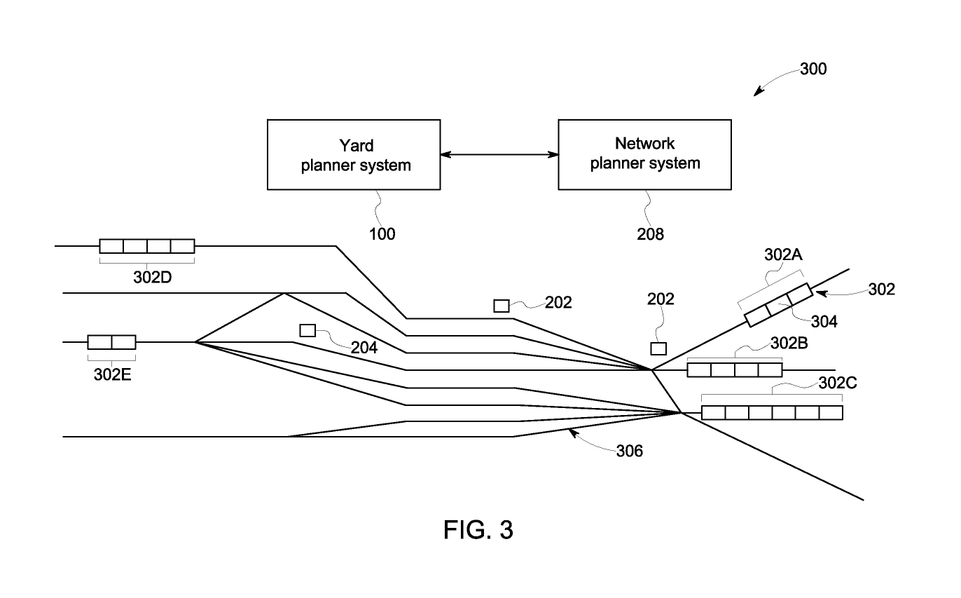

FIG. 3 illustrates a schematic representation of a vehicle yard 300, according to an embodiment of the present disclosure. Referring to FIGS. 2 and 3, the yard planner system 100 may include a monitor system 200 that obtains the input(s) information used by the yard planner system 100 to create the yard plans and monitor the state of the yard and the vehicles in the yard. For example, the monitor system 200 may receive the yard state information 102 from operators 106 (shown in FIG. 1) using yard workstations 202, such as computer workstations, tablet computers, mobile phones, and/or other devices. In general, the workstations 202 may represent computing devices having display devices (for example, computer monitors, touchscreens, LCD displays, projectors, or the like) that visually present information to users of the workstations 202. At least some of the yard state information 102 additionally or alternatively may be received from one or more yard sensors 204 that measure or otherwise obtain data indicative of the yard state information. The sensors 204 may include transponders, video cameras, track circuits, or the like, that detect the presence of consists 302 (e.g., consists 302A, 302B, 302C, 302D, 302E) and/or vehicles 304 at one or more locations in the vehicle yard 300, and/or detect which operations are being performed on the vehicles. While five consists are shown in FIG. 3 and various numbers of vehicles are shown in the consists in FIG. 3, the number and/or arrangement of the consists and vehicles may differ from that shown in FIG. 3.

One example of such input information includes vehicle connection goals. A vehicle connection goal represents an outbound vehicle consist that a vehicle identified with the connection goal is to be included in when the vehicle leaves the vehicle yard 300. For example, when a first consist enters into the yard, the first consist may include one or more vehicles that are scheduled for different destinations when these vehicles depart the yard 300. In order to ensure that these vehicles reach the appropriate destinations, the monitor system 200 may track which outbound consists are scheduled to depart for different destinations (or other vehicle yards) and which destinations that the different vehicles in the inbound consists are to travel toward. The yard plan may be created and/or modified to ensure that the vehicles are included in the outbound consists that are scheduled to travel toward or to the destinations of the various vehicles. For example, a yard plan may be created so that the vehicles included in an outbound consist are scheduled to travel to the same destination location or other vehicle yard.

In at least one embodiment, the monitor system 200 may receive alternate vehicle connection goals. An alternate vehicle connection goal for a vehicle may represent one or more additional output vehicle consists that the vehicle may be included in for departing the vehicle yard if a primary vehicle connection goal is unattainable. For example, the yard planner system 100 may be unable to generate a yard plan to place one or more vehicles in the outbound consists of the vehicle connection goals for those vehicles. The alternate vehicle connection goals for these vehicles may be used to generate a yard plan so that the vehicles are included in alternate outbound consists.

The monitor system 200 may obtain the vehicle connection goals (for example, primary and/or alternate) for the vehicles from a network planner system 208. The network planner system 208 represents a system that creates schedules for the consists to travel through a network of routes that are connected with the vehicle yard 300 that is scheduled by the yard planner system 100. The network planner system 208 may create schedules for several consists to concurrently travel in the network of routes. The schedules may direct the consists to take designated routes from a starting location to a destination location, while traveling through one or more intermediate locations. Some of these schedules may direct at least some of the consists to travel into the yard that is scheduled by the yard planner system. The schedules of these consists may dictate additional locations that one or more vehicles in the consists are to travel to after leaving the vehicle yard, such as a final destination of a rail car or another yard that the rail car is to travel to during a trip to the final destination. The yard planner system 100 may obtain these schedules (or portions thereof) from the network planner system 208 as network scheduling information.

The network scheduling information (including vehicle connection goals) obtained by the yard planner system 100 may describe the intended routing of various vehicles from an origin location to a destination location, as well as a list of vehicle yards that the vehicles are to travel to and enter, the specific consists that the vehicles are planned to ride in during each portion (for example, leg) of the travel of the vehicles to the respective destination locations. The yard planner system 100 may use this network scheduling information to identify vehicle connection goals, which indicate the outbound consists that the various vehicles are to be included in when the vehicles leave the yard. The yard planner system 100 also may use this network scheduling information to identify alternative consists for the vehicles to be included in when the vehicles leave the yard.

The yard planner system 100 may also include a bandwidth system 206 that monitors constraints on the processing operations that are performed on one or more of the vehicles within the vehicle yard 300 in order to move the vehicles into, through, and out of the vehicle yard 300. The bandwidth system 206 may receive data representative of the processing constraints from one or more of the operators 106, sensors 204, and/or management information systems 108 in order to track and/or update the processing constraints over time. The yard plans that are generated by the yard planner system 100 may be updated when the processing constraints change or significantly change.

For example, the bandwidth system 206 may track route configurations in the yard 300. The route configuration includes the layout (for example, arrangement, orientations, allowed directions of travel, intersections, and the like) of routes 306 (for example, tracks) within the vehicle yard 300 on which the vehicles travel and/or are processed in the yard. The route configuration may also include the capacities of the routes in the yard 300, such as the sizes of the routes (for example, lengths). Larger (for example, longer) stretches of the routes 306 have a larger capacity for receiving vehicles than smaller (for example, shorter) stretches of the routes 306. These capacities may change with respect to time as the number of vehicles in the yard 300 (and on the routes 306) changes, as segments of the route are unavailable due to maintenance or repair, as segments of the routes become available after being unavailable due to maintenance or repair, or the like.

In at least one embodiment, the yard planner system 100 may identify one or more opportunities for track maintenance within one or more idle times between planned activities. The yard planner system 100 may reserve one or more yard resources, such as tracks, facilities, equipment, or the like, for the opportunities. For example, the yard planner system 100 may identify unused resources within the yard (such as track segments, idle personnel, idle equipment, and the like), and then reserve one or more of these resources in the yard plan that is created and updated. In at least one embodiment, one or more of these resources may be reserved in case of an emergency, faulty equipment, unplanned track outage, a scheduled employee calling in sick, and/or the like.

As another example of processing constraints that may be monitored, the bandwidth system 206 may track vehicle inventories in the vehicle yard 300. Vehicle inventories may represent the locations of various (or all) of the vehicles in the vehicle yard 300, the intended (for example, scheduled) locations and/or routes that the vehicles are to occupy and/or travel along in the vehicle yard 300, the current and/or future (for example, scheduled) status of the processing operations being performed on the various vehicles in the yard 300, and the like.

Another example of processing constraints that may be monitored include resource availabilities. Resources in the yard 300 include any physical item or person in the yard 300 that may be used or involved in moving or processing vehicles. These resources can include the yard crews, hump and pullback engines, the route topology, and the like. These resources can be constraints on the yard plan to ensure that the plan is operationally feasible.

For example, the resources may include operators 106 that perform the processing operations on the vehicles (for example, yard crews, repair men, and the like). Due to limitations on the length of time that the crews may be able or allowed to work, the length of time required to complete various processing operations, and the times at which vehicles are scheduled or expected to be processed at various operations, the availabilities of these operators 106 may change with respect to time. The bandwidth system 206 may track increases or decreases in the availabilities of these yard crews. The resources may include equipment in the vehicle yard 300 that is used to perform some of the processing operations. With respect to a rail yard, one example of such equipment is a switching locomotive used to move rail cars between tracks in the yard 300. Other types of equipment may also be used to perform various operations on the vehicles. Due to actual and/or scheduled uses of the equipment and the limited number of equipment in the yard, the availability of the equipment may change throughout the day and be tracked by the bandwidth system 206.

Another example of a processing constraint that may be monitored includes route maintenance. Various segments of the routes may be unavailable at times due to planned and/or unplanned maintenance or repair on the route segments. The bandwidth system 206 may monitor when the routes 306 are available for receiving vehicles due to the planned and/or unplanned maintenance to assist the yard planner system 100 in scheduling the vehicles to use the routes 306 that are available when the routes 306 are available or scheduled to be available.

Another example of a processing constraint includes time requirements for the planned and/or scheduled processing operations. The bandwidth system 206 may monitor which processing operations are being performed in different locations in the vehicle yard, when these processing operations are scheduled or otherwise expected to be completed, when other processing operations are scheduled to begin, and the like, in order to track when these processing operations are available for other vehicles in the yard 300.

The monitor system 200 and/or bandwidth system 206 may obtain the information described above via a communication system 209. The communication system 209 may include electronic circuitry and other hardware that communicates data signals with the network planner system 208, the yard sensors 204, and/or the yard workstations 202. For example, the communication system 209 may include one or more antennas 210 for wirelessly communicating with the network planner system 208, sensors 204, and/or workstations 202. Additionally or alternatively, the communication system 209 may be coupled with a conductive communication pathway 212, such as one or more cables, busses, wires, rails, or the like, through which the information may be communicated with the network planner system 208, the yard sensors 204, and/or the yard workstations 202. As described below, the communication system 209 may send data signals to one or more of the yard workstations 202 in order to visually present the yard 300 to users of the workstations 202.

The yard planner system 100 may also include a generation system 214 that plans movements of vehicles through the yard 300 and processing activities to be performed on the vehicles to create a yard plan. As described above, the yard plan is a schedule of movements of the vehicles through different locations and/or along different routes in the yard, as well as a schedule of processing operations to be performed on or with the vehicles at various locations of the vehicles, as the vehicles move from an inbound consist to an outbound consist.

The yard plan that is created by the generation system 214 provides a detailed schedule of vehicle processing operations while also specifying time, resources, and vehicles on which each operation is to be performed. As described above, the generation system 214 may receive a schedule of inbound consists, such as for the next n-hours into the future, where n is a configurable length of time. For each inbound consist, the generation system may be given a list of the vehicles in the inbound consist (for example, one or more of the consists 302A, 302B, 302C) and/or an order or other location in which the vehicles are in the inbound consist. Each vehicle may be associated with and/or identified by a block code that indicates a destination or next stop for the vehicle after the vehicle departs from the yard on an outbound consist (for example, one or more of the consists 302D, 302E). The yard planner system 100 may obtain the outbound train to which the vehicle is assigned by the network planner system, and may obtain a list of acceptable alternative outbound consists, along with the order in which that block may appear in each outbound consist. The yard planner system 100 may use the schedule of outbound consists, the schedule of available processing resources (for example, engines, crews, and routes), and the current state of the vehicle yard 300 to schedule the sequence of operations needed to process each inbound vehicle and prepare the vehicle for departure on an outbound vehicle consist, while avoiding exceeding the capacity of the yard 300 to move and/or process the vehicles.

In at least one embodiment, with respect to the rail yard 300, the process of planning an efficient flow of the vehicles through the yard 300 to generate a yard plan includes managing arrival of each inbound vehicle consist, in accordance with the inbound schedule obtained from the network planner system, subject to capacity of the yard to receive the inbound consists; assigning receiving segments of the routes to each inbound consist, in accordance with the inbound and outbound schedules and departure objectives of the consists, subject to capacity of the yard; scheduling air bleeding and vehicle inspection activities at various locations in the yard; scheduling the sequence of vehicles to move to a hump in the yard; assigning each vehicle to a classification route segment where the vehicles are sorted and/or grouped together in blocks for continued movements or operations in the yard; scheduling the sequence of vehicles to pull from the classification route segments to departure route segments where the vehicles or blocks of vehicles are grouped together; assigning outbound vehicles to departure segments of the routes where these vehicles are assembled into outbound consists; scheduling outbound inspection operations of the outbound consists; and managing (for example, scheduling) outbound consists departures from the yard 300. Some factors that are considered by the yard planner system 100 in pullback and outbound consist building include block standing order requirements of the outbound consist, capacity of the consist (for example, how much weight can the consist pull), departure directions of the consists, building rules that restrict how the vehicles can be arranged in the consists, outbound consist on-time performance (for example, how often does a vehicle historically leave the yard at the scheduled time), departure pullback route accessibility and lengths, locking of classification routes while pullback operations are in progress, and the like.

The yard plan may extend for a configurable period of time into the future, which may be referred to as the planning horizon. The planning horizon may be modified by a human operator of the yard planner system 100. The level of certainty in the yard plan may decrease as the yard plan extends further into the future. For example, the adherence of the vehicles to the yard plan may deviate more significantly over time due to the assumed constraints on the yard changing with respect to time, unplanned changes in arrival times of consists, unplanned maintenance on routes within the yard, and the like. The yard planner system 100 includes a configurable planning horizon that allows a human operator to control how many hours into the future the sequence of activities may be planned. The planning horizon may be a rolling calculation based on the current system time.

The yard planner system 100 may create a plan so as to accommodate a schedule of anticipated route blockages, such as scheduled route maintenance activities (characterized by affected segments of the route), the expected time of occurrence, and the expected duration. The plan may be modified to accommodate unscheduled route blockages, such as short-run or misrouted vehicles that block access to certain classification routes in the yard.

In at least one embodiment, the generation system 214 may automatically schedule the movements and processing operations of the vehicles so that the percentage of vehicles that achieve the respective connection goals is increased over manually scheduling these movements and operations, subject to the processing constraints such as on-time arrivals of the inbound consists to the yard, processing resources being available, (for example, yard crews, yard track, hump control system, and yard engines being available), scheduled maintenance activities on the routes and/or equipment in the yard, and the capacity of the yard to handle outbound consists. For example, in formulating a yard plan, the generation system 214 may attempt different combinations and sequential orders of which route segments in the yard are used to move the different vehicles, which processing operations are performed on the different vehicles, when the vehicles are moved along the different route segments, when the processing operations are performed, and the like, in order to identify one or more schedules of these activities that result in at least some of the vehicles achieving their respective connection goals (for example, being placed into the correct outbound consist that is headed to or toward the next destination of the vehicle) without violating the constraints being monitored by the bandwidth system 206. These different attempted combinations and orders may be referred to as potential schedules.

The generation system 214 may not be able to identify a potential schedule that results in all of the vehicles achieving the respective connection goals subject to the processing constraints of the yard (as monitored by the bandwidth system 206). However, the generation system 214 may be able to identify several different potential schedules that result in different percentages or other amounts of these vehicles achieving the respective connection goals. The generation system 214 may select the potential schedule having the largest percentage of vehicles achieving the respective connection goals (or the potential schedule having a larger percentage of these vehicles than one or more other, but not all, potential schedules) as the yard plan to be used. Optionally, the generation system 214 may select the potential schedule that reduces the amount of time that the vehicles are in the yard for the various movements and processing operations relative to one or more other potential schedules. Additionally or alternatively, the generation system may identify several potential schedules and present these potential schedules to a human operator, such as on a display device of a computer. The operator may then manually select potential schedule from those displayed potential schedules. The potential schedule that is selected by the generation system 214 or the human operator may be identified as a yard plan. The yard plan includes the sequence of vehicle processing operations and the resource reservations necessary to accomplish these operations.

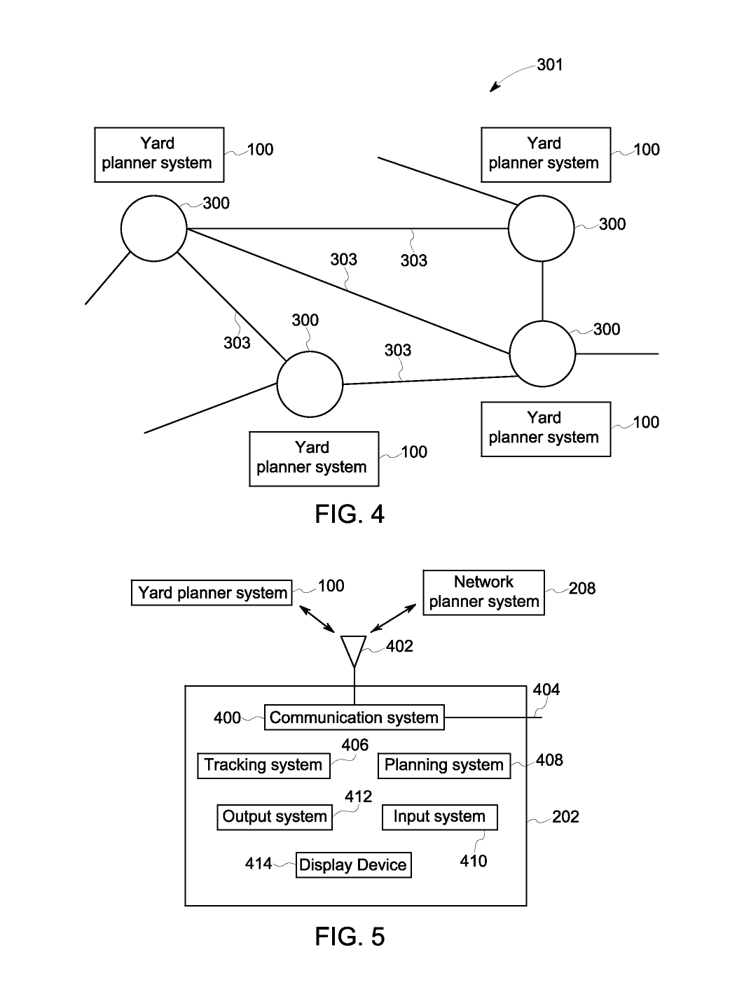

FIG. 4 illustrates a schematic representation of a route network 301, according to an embodiment of the present disclosure. As shown in FIG. 4, several different yards 300 may be interconnected with each other by routes 303 that are outside of the yards 300. The combination of yards 300 and routes 303 forms the route network 301 over which vehicle consists 302 (as shown in FIG. 3) can travel to destination locations. The yard planner systems 100 for each of the yards 300 may coordinate the yard plans generated for the respective yards with the network planner system 208 (shown in FIG. 2), which generates schedules to coordinate movements of the consists through the network 301. For example, the yard planner system 100 for one or more of the yards 300 may communicate a message (for example, via the communication system 209) that indicates the time or range of times at which the yard 300 will be ready to receive a consist and/or which route inside the yard that the inbound consist should use to enter into the yard. This yard planner system 100 can communicate a message that indicates the time or range of times at which each outbound consist is expected (for example, scheduled) to depart the yard and/or which route segment in the yard that the outbound consist is to use to leave the yard. These messages can be communicated to the network planner system 100 and/or directly to the consists so that movements outside of the yards 300 can be coordinated with the yard plans.

Generating the yard plans for the vehicle yards 300 may significantly improve the efficiency at which vehicle consists move through a network of routes. For example, for a departing train that is scheduled to leave a vehicle yard at a scheduled departure time on a first route, assume that an opposing train traveling along the first route will need to be held at a siding or otherwise delayed while waiting for the departing train to emerge from the yard. The velocity of the opposing train if not delayed is v0=d/T, where d represents the crew segment length in miles and T is the nominal run time of the opposing train over that segment. If the opposing train is further delayed by the departing train leaving the yard later than scheduled, the opposing train velocity can become v1=d/(T+Δ), where Δ represents the amount of time that the opposing train spends waiting for the late departing train to emerge from the yard. As a result, the ratio of the velocity of the opposing train without being further delayed to the velocity if additionally delayed is v0/v1=(T+Δ)/T, and the net increase in average speed of the opposing train can be Δ/T. Consequently, the fraction of trains that are delayed by trains that are delayed from departing the yard may be estimated with an estimate of a current departure adherence (the estimate of how long trains are delayed from leaving the yard behind schedule, Δ) and run time (T).

FIG. 5 illustrates a schematic representation of a yard workstation 202, according to an embodiment of the present disclosure. The workstation 202 may include a communication system 400 that may be similar to the communication system 208 shown in FIG. 2. For example, the communication system 400 may wirelessly communicate with the yard planner system 100 and/or the network planner system 208 using an antenna and associated circuitry 402, and/or may communicate with the yard planner system and/or network planner system through one or more conductive communication pathways 404. The workstation 202 may receive schedules of the consists traveling to and/or departing from a yard from the network planner system 100 and may receive yard plans from the yard planner system 100. The communication system 400 also may receive data from one or more other workstations, yard sensors 204, and the like.

The workstation 202 may include a tracking system 406 that monitors the current state of the yard. For example, the tracking system 406 may receive, via the communication system 400, data from the yard sensors, other workstations, and the like, to determine where various vehicles are currently located in the yard, the status of the processing operations currently being performed on the vehicles, the state of the route segments (e.g., tracks) in the yard (e.g., whether the route segments are blocked, available for travel, under repair, or the like).

A planning system 408 of the workstation 202 receives (via the communication system 400) the yard plan from the yard planner system 100 and updates to the yard plan. The planning system 408 obtains the yard plan and updates in order to ensure that the user of the workstation 202 is provided with information on future planned activities for the various vehicles displayed on the workstation to the user.

An input system 410 of the workstation 202 receives user input. The input system 410 may receive the input via the communication system 400. Additionally or alternatively, the input system 410 may include or represent one or more input devices that are used by the user of the workstation to generate the input, such as an electronic mouse, stylus, touchscreen, microphone, or the like. The input system 410 may receive input from the user to change the information that is displayed on the workstation 202.

An output system 412 of the workstation 202 generates output signals that are sent to a display device 414 for visual presentation to the user. The output system 412 may receive instructions and data from the tracking system 406, planning system 408, and/or input system 410, and direct the display device 414 to visually present an image of the yard, as described below. The display device 414 may include one or more electronic components that generate the visual presentation of the yard for viewing by the user. Several examples of such presentations are described herein, but not all embodiments of the subject matter described herein are limited to these examples.

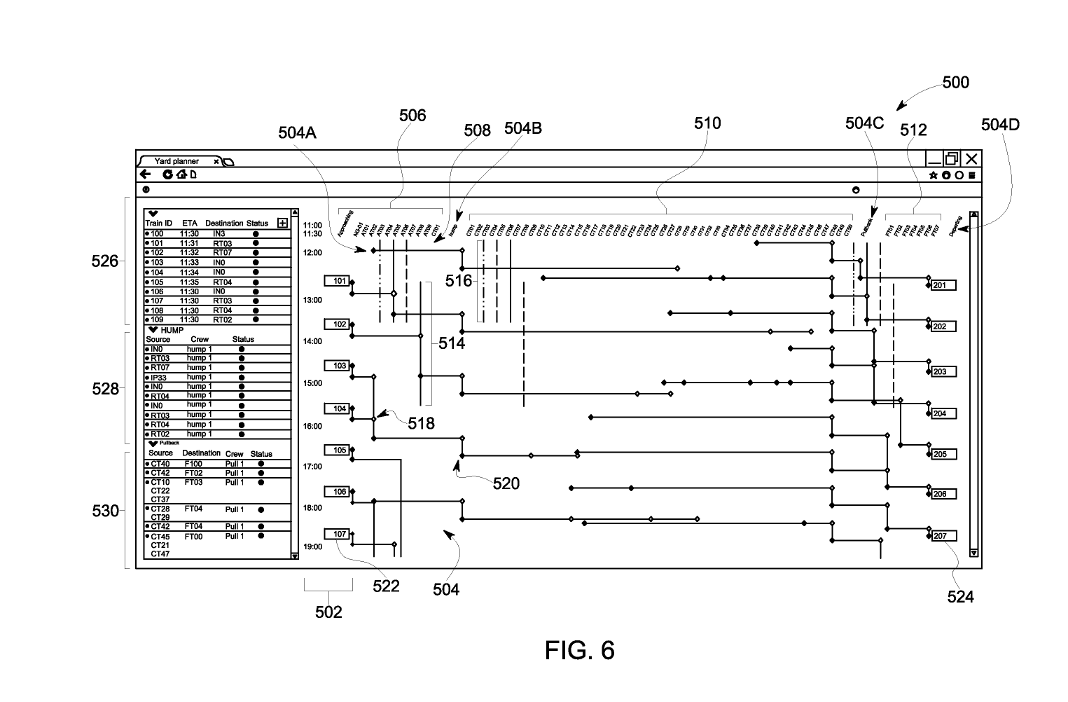

FIG. 6 illustrates a visual presentation 500 of a vehicle yard as shown on the display device 414 of the workstation 202, according to an embodiment of the present disclosure. Additionally, or alternatively, the visual presentation 500 may be shown on a display of the vehicle planner system 100. The visual presentation 500 may include a time bar 502 that represents different times, such as current and/or future times. The illustrated time bar 502 extends in a downward direction in the perspective of FIG. 6 such that earlier times are shown at the top of the time bar 502 and later times are shown lower in the time bar 502. For example, the illustrated time bar extends from approximately 11:30 am to approximately 7:00 pm. Optionally, the time bar 502 may extend in an upward direction, a horizontal direction, or another direction.

Different routes in the yard may be represented by vertical lines 504 extending parallel to the time bar 502. These lines 504 may be referred to as route lines and may be grouped into the different types of routes. For example, the route lines for those routes that are used for receiving inbound consists and/or separating the vehicles in the consists from each other may be positioned closer together (relative to other route lines) in a receiving group 506. An approaching route line 504A is used to indicate which inbound consists are approaching entrance into the yard. A hump route line 504B indicates which vehicles in the yard are being processed by the hump of the vehicle yard. A classification group 510 includes those routes that are used for sorting the vehicles separated from the inbound consists and assembling these separated vehicles into blocks for further processing in the yard. A “block” of vehicles includes two or more vehicles mechanically coupled with each other in the yard. In one aspect, a block of vehicles may not include a propulsion-generating vehicle mechanically coupled with the other non-propulsion generating vehicles in the block.

A pullback route line 504C indicates which vehicles or blocks of vehicles are on the pullback route of the yard. A forwarding group 512 includes the routes that are used for combining two or more vehicles and/or blocks of vehicles into outbound consists for leaving the vehicle yard. A departing route line 504D indicates which vehicles, blocks of vehicles, and/or consists are leaving the yard, such as in an outbound consist.

One or more changed status portions 514, 516 of the route lines 504 may be shown differently from the remainders of the same route lines to indicate a change in state or availability of that route line during the corresponding time period. For example, the route lines may be drawn in a first color and/or using a dashed line. The changed status portions of the route lines may be drawn in a different, second color and/or using a solid line so that the user may clearly see a difference between the changed status portions and the remainder of the route lines. The changed status portions extend from a starting time period to an ending time period along the time bar 502 to indicate when the status of the corresponding route changes. The changed status can indicate that the route is unavailable for travel by vehicles and/or is being repaired or otherwise maintained during the corresponding time period. For example, the changed status portion 514 can be drawn in a solid red line (or other color and/or line) to indicate that the corresponding route is unavailable for processing vehicles from approximately 12:30 pm until approximately 3:30 pm. This changed status portion can clearly and easily notify the user that the route cannot be used during this time period. The changed status portion 516 can be drawn in a solid blue line (or other color and/or line) to indicate that the corresponding route is being repaired or maintained from approximately 11:30 am until approximately 1:30 pm. This changed status portion can clearly and easily notify the user that the route may have limited capacity to process vehicles during this time period.

Symbols 518, 520 are shown on the route lines 504 to indicate processing operations that are being performed or are scheduled to be performed on blocks of one or more vehicles. In the illustrated example, the symbol 518 is referred to as an origin symbol that indicates when and where a processing operation begins and the different symbol 520 is referred to as a destination symbol that indicates when the same processing operation ends. Display of the beginning symbol on a route line can notify the user that a processing operation begins on the route represented by that route line at the time indicated by the time bar 502.

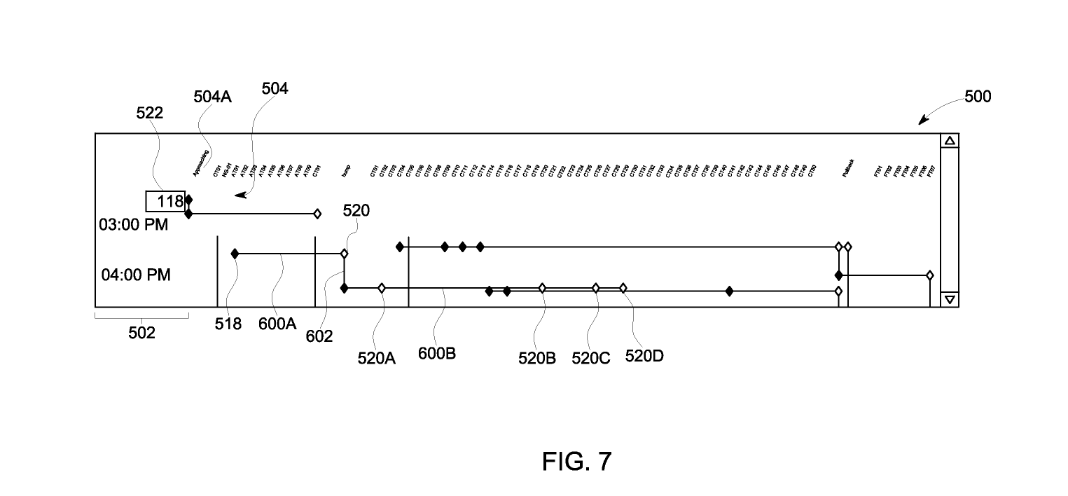

FIG. 7 illustrates a portion of the visual presentation 500 of a vehicle yard as shown on the display device 414 of the workstation 202, according to an embodiment of the present disclosure. Additionally, or alternatively, the visual presentation 500 may be shown on a display of the vehicle planner system 100. Referring to FIGS. 6 and 7, the workstation 202 may display a processing line 600A that connects an origin symbol 518 with a destination symbol 520 for a processing operation (for example, moving a vehicle from a first route segment to a different, second route segment in the yard, loading/unloading cargo, performing maintenance on the vehicle, bleeding brakes of the vehicle, and the like). For example, the processing line 600A may be a horizontal or other line that traverses one or more route lines 504.

The processing line 600A connects an origin symbol 518 on the route line 504 associated with the route “RT01” with a destination symbol 520 on the route line associated with the hump route in the yard. This indicates that the processing operation represented by the crossing processing line involves movement of the vehicle or blocks of vehicles represented by the origin and destination symbols from the route RT01 to the hump in the yard. A processing line 600B connects one origin symbol with four destination symbols 520A, 520B, 520C, 520D, which may indicate that the block of vehicles represented by the origin symbol of this processing line move to different routes indicated by the different destination symbols. For example, the processing operation represented by the line 600B may involve moving one subset of the vehicles in the block of vehicles represented by the origin symbol to the route CT02 (which is represented by the destination symbol 520A), another subset of these vehicles may be moved to the route CT20 (which is represented by the destination symbol 520B), and so on.

A timing line 602 may be displayed to represent when and/or how long a processing operation is expected (for example, scheduled) to occur and/or take to complete, or when and/or how long the processing operation actually did occur and/or take to complete. The timing line 602 may be displayed so as to connect with the processing line 600A and/or 600B so that the user can clearly see when and how long the processing operation represented by the combined processing line 600A and 600B will take to complete. The length that the timing line 602 extends along (for example, parallel to) the timing bar 502 represents the length of time that the processing operation is expected to take to complete. For example, the timing line shown in FIG. 7 indicates that moving the block of vehicles from the route RT01 to the hump route is scheduled to occur from approximately 3:35 pm to 4:05 pm and take approximately thirty minutes to complete.

Inbound symbols 522 represent inbound consists that are scheduled to arrive at the yard and outbound symbols 524 represent outbound consists that are scheduled to leave the yard. The inbound and outbound symbols 522 and 524 may include textual indicia (for example, white text on a black box or other indicia) that indicates the consist to the user. The inbound symbols are visually displayed as being connected with the approaching route line 504A at positions along the time bar 502 that represent when the inbound consists are scheduled to arrive in the yard. Similarly, the outbound symbols are visually displayed as being connected with the departing route line 504D at positions along the time bar 502 that represent when the outbound consists are scheduled to depart from the yard.

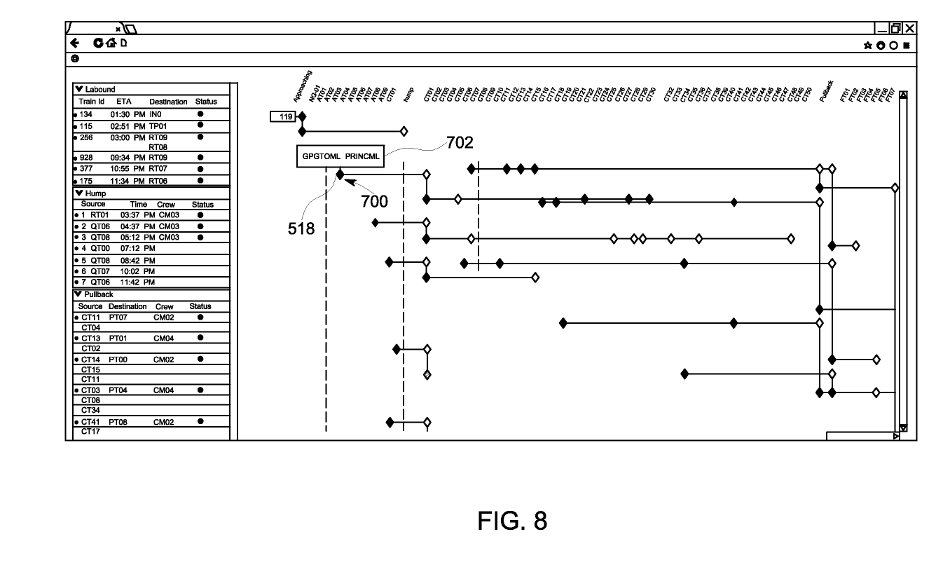

FIG. 8 illustrates another view of the visual presentation 500, according to an embodiment of the present disclosure. The visual presentation 500 may be shown on a visual display of the vehicle planner system 100 and/or a workstation 200. In at least one embodiment, the user may obtain additional information about which vehicles and/or blocks of vehicles are being processed according to the different processing lines 600 by selecting one or more of the origin and/or destination symbols 518, 520. For example, the user can “click” on the symbols using the input device of the workstation, the user can move a user-controlled icon 700 (for example, an arrowhead, hourglass, or other icon) on the display device over the symbol that the user wants to view more information, or the like. The output system of the workstation can then cause identifying indicia 702 to be displayed. The identifying indicia 702 may include alpha-numeric text that identifies the vehicles and/or blocks of vehicles that are represented by the selected symbol. In the illustrated example, the user has selected an origin symbol that represents blocks of vehicles identified as GPGTOML and PRINCML. The user can select a symbol in order to determine which vehicles or blocks of vehicles are being processed during the operation represented by the processing line that is connected with the selected symbol.

Referring again to FIG. 6, the visual presentation 500 may additionally display status windows 526, 528, 530, which may provide information to the user about the current status of various resources and/or inventory in the yard. For example, the status window 526 lists the scheduled arrival time and status (for example, delayed, arriving early, or the like) of inbound consists. The status window 528 lists the current status of blocks of vehicles that are on one or more selected routes, such as the hump in the yard. The status window 530 lists the current status of blocks of vehicles that are on another selected route, such as the pullback route in the yard.

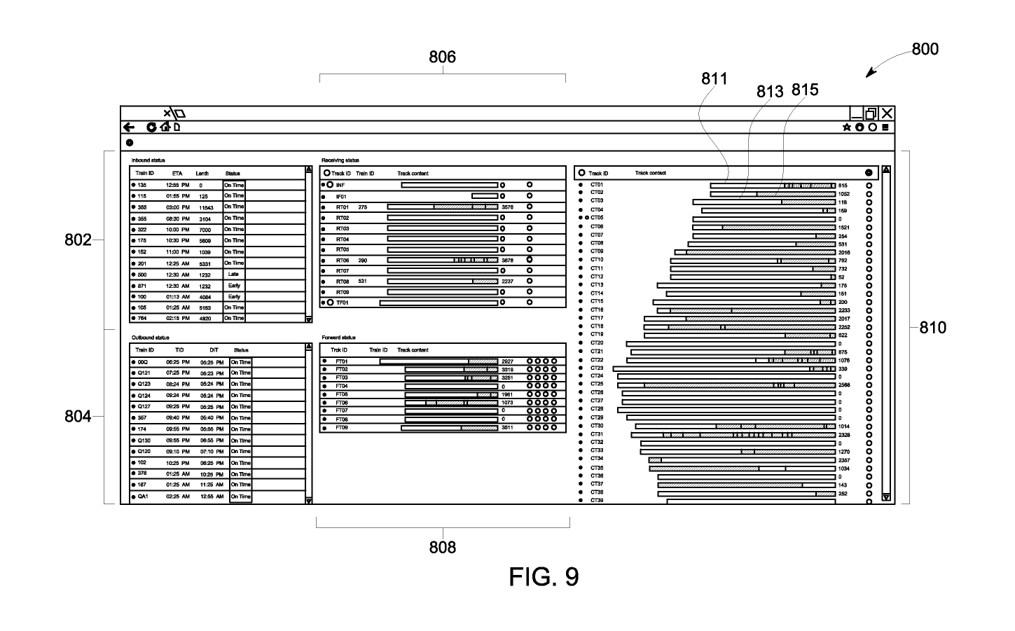

FIG. 9 illustrates another visual presentation 800 that the workstation 202 may display for the user, according to an embodiment of the present disclosure. Additionally, or alternatively, the visual presentation 800 may be shown on a display of the vehicle planner system 100. The visual presentation 800 includes several status windows 802, 804, 806, 808, 810. An inbound status window 802 provides the current status of inbound consists. For example, the inbound status window 802 may list the inbound consists by a unique identifier (for example, “TrainID”), the estimated or scheduled time of arrival into the yard (for example, “ETA”), the size of the consist (for example, in terms of vehicle or car lengths, or “Length”), and/or the status of the consist (for example, “On Time,” “Late,” “Early,” and the like). An outbound status window 804 provides the current status of outbound consists. For example, the outbound status window 804 may list the outbound consists by a unique identifier (for example, “TrainID”), the estimated or scheduled time of departure from the yard, and/or the status of the consist (for example, “On Time,” “Late,” “Early,” and the like).

A receiving status window 806 may display the utilization of the routes in the yard that are included in the receiving group 506 (shown in FIG. 6). The receiving status window 806 may list the various routes included in the receiving group, as well as the amount (for example, length) of the routes that are currently occupied by one or more blocks of vehicles. The receiving status window 806 may indicate if one or more of these routes are unavailable, such as when the routes are being repaired.

A forwarding status window 808 may display the utilization of the routes in the yard that are included in the forwarding group 512 (shown in FIG. 6). The forwarding status window 808 can list the various routes included in the forwarding group, as well as the amount (for example, length) of the routes that are currently occupied by one or more blocks of vehicles. The forwarding status window 808 may indicate if one or more of these routes are unavailable, such as when the routes are being repaired.

A classification status window 810 may display the utilization of the routes in the yard that are included in the classification group 510 (shown in FIG. 6). The classification status window 810 may list the various routes included in the classification group, as well as the amount (for example, length) of the routes that are currently occupied by one or more blocks of vehicles. The classification status window 810 may indicate if one or more of these routes are unavailable, such as when the routes are being repaired. For example, the status window 810 may graphics 811, such as linear bars, that include open areas 813 (for example, vacant areas) that represent empty, vacant track, and shaded areas 815 (for example, occupied areas) that represent that track is occupied or being used. As such, the graphics 811 may represent current route capacity.

The visual presentation 800 may also include various other types of information used for planning purposes. For example, the visual presentation 800 may also include a weather window that may display information regarding current and future weather. The yard planner system may utilize information regarding the weather, for example, the formulate and/or update a yard plan.

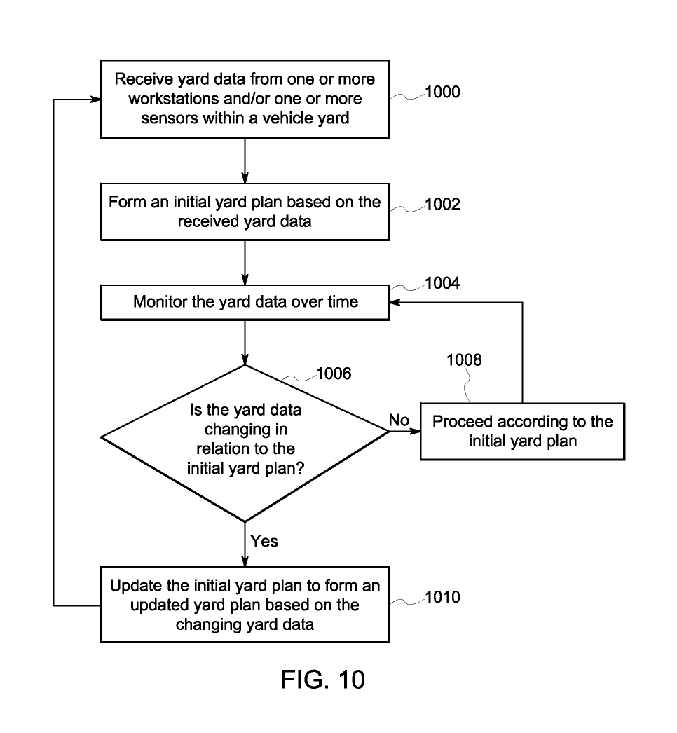

FIG. 10 illustrates a flow chart of a method of managing or planning a vehicle yard, according to an embodiment of the present disclosure. The method begins at 1000, in which yard data is received from one or more workstations and/or one or more sensors within a vehicle yard. For example, a yard planning system or processor(s) may receive the yard data.

At 1002, an initial yard plan is formed based on the received yard data. Then, at 1004, the yard data is monitored over time. At 1006, it is determined whether the yard data is changing in relation to the initial yard plan. That is, it is determined whether the initial yard plan is still applicable based on the monitored yard data. If the yard data is not changing in relation to the initial yard plan, the method proceeds to 1008, in which movement, operations, and the like of the vehicle yard proceed according to the initial yard plan. The process then returns to 1004.

If, however, the yard data is changing in relation to the initial yard plan, the method proceeds to 1010, in which the initial yard plan is updated to form an updated yard plan based on the changing yard data. The method then returns to 1000.

Certain embodiments of the present disclosure provide systems and methods of accumulating, managing and displaying yard state and the sequence and timing of car processing activities in a vehicle yard, such as a rail yard. Embodiments of the present disclosure provide systems and methods for managing and assigning resources to planned activities. The yard planner system, for example, may be configured to display and resolve conflicts in resource assignment, for example. The yard planner system may resolve delays associated with resource conflicts (such as track usage, vehicle usage, and/or the like). The yard planner system may generate, update, and/or manage connection goals as a consequence of resource conflicts and delays.

Certain embodiments of the present disclosure provide systems and methods for displaying and tracking work status, progress and expected completion times of planned car processing activities.

Certain embodiments of the present disclosure provide systems and methods for displaying a degree or amount of occupancy/vacancy of different tracks in rail yard. For example, the yard planner system may determine and display vehicle yard inventory. The systems and methods may display separation between groups of same type or category of vehicles on a particular track or route.

The yard planner system may visually display various information to a user, such as late-arriving vehicles, operations that are behind schedule, alarm states, and/or vehicles that are scheduled that will leave yard behind schedule differently than other car(s). Tracks in different areas of the rail yard may be displayed in different locations on a display device.

The yard planner system, for example, may receive operator input to select an inbound vehicle (such as a train, car, or outbound train), and change the display of vehicles associated with and/or scheduled. The yard planner system may receive input selecting a group of vehicle and display additional information for those vehicles, such as length, weight, class/category, and the like.

The yard planner system may display various types of information on a display device, such as shown in FIGS. 6-9. For example, information regarding classes of vehicles, crew call time, size limits, track occupancy, vehicle occupancy, and the like may be determined and displayed. Planned movement of vehicles through one or more tracks of the rail yard, into outbound trains, and out of yard may be determined and shown. As shown in FIGS. 6-9, time may be displayed along a first axis/direction, identifiers of different tracks may be displayed along a second axis/direction, car icons may displayed for cars at locations indicative of when cars enter into tracks and exit out of tracks, occupancy symbols may be displayed along the first axis to connect icons for cars, represent how long cars are on associated tracks, and the like. Additionally, movement symbols may be displayed along the second axis to connect icons for cars on different tracks, represent movement of cars between different tracks.

The yard planner system and method may also receive operator input that selects an inbound or outbound train/car, and highlight icons and symbols representative of cars in the same train, for example. Inbound train icons may be show that represent when inbound trains arrive, and outbound train icons may be shown that represent when outbound trains leave.

The yard planner system and method may also receive operator input to block selected track segments for periods of time, display blocked symbol along the first axis, the size/length representative of how long segment is blocked, and the like. The yard planner system and method may then determine how the blocked area(s) impact processing of vehicles and modify rail yard plan accordingly.

Certain embodiments of the present disclosure provide a method that may include monitoring receipt of rail cars into a rail yard from inbound trains, and monitoring actual processing of the rail cars in the rail yard according to a movement plan. The movement plan may include scheduled processing of the rail cars by one or more resources of the rail yard. The scheduled processing may dictate separation of the rail cars from the inbound train, movement of the cars to different processing tracks in the rail yard, performance of tasks on the cars to prepare the cars for departure from the rail yard in one or more outbound trains, and grouping of the cars into the one or more outbound trains. The method may also include determining conflicts between the actual processing of the rail cars and the scheduled processing of the rail cars, automatically resolving the conflicts between the actual processing and the scheduled processing of the rail cars by modifying the movement plan, and automatically communicating command signals to the one or more resources to notify the one or more resources of modifications to the movement plan.

Certain embodiments of the present disclosure provide a yard planner system and method that complements an operational staff of a vehicle yard by providing analytical support and producing movement plans (for example, schedules) within the yard for the vehicles. By integrating with existing rail management information systems, yard sensors, and other input mechanism, the yard planner system and method may be aware of the state of the entire yard at any point in time. The yard planner system and method produces a plan detailing sequences of activities in the yard to be performed in receiving vehicles into the yard, processing the vehicles within the yard, and getting the vehicles into outbound consists departing from the yard. Execution of the yard plan increases efficiency with respect to overall yard operations, decreases dwell times of vehicles, increases orderliness, and/or increases on-time departures from the yard relative to manually scheduling the yard plan and/or scheduling the yard plan without monitoring the state of the yard and/or without taking into consideration yard constraints.

In at least one embodiment, a yard planner system and method is provided for accumulating, managing, and displaying yard state, sequence and timing of vehicle processing activities. The yard planner system and method may manage and assign resources to planned activities for moving vehicles into, through, and out of a vehicle yard. The yard planner system and method visualizes and resolves conflicts in assignment of resources to perform the planned activities. Consequential delays associated with resource conflicts may be visualized and resolved. The system and method may visualize and manage impacted vehicle connection goals as a consequence of resource conflicts and delays. The yard operating plan may be created for variable time periods into the future, such as at least two work shifts or more (sixteen hours or more) into the future. The system and method may visually represent dependencies between the planned activities for the vehicles and/or the sequences of the planned activities for viewing by a human operator, such as an approaching consist sequence, a hump operation sequence of the yard, a pull down sequence (for example, train building), a consist departure sequence, route assignments and planned progressions of vehicle locations through the yard (for example, receiving routes, classification routes, and/or forwarding routes of the yard), yard ingress and/or egress by vehicle consists, or the like.

The system and method may coordinate the yard ingress and/or egress by the vehicle consists with line of road operations, such as movements of the vehicle consists outside of the vehicle yard. The system and method may coordinate the yard ingress and/or egress by the vehicle consists with routes leading in and/or routes leading out of the yard to and/or from the line of road that is disposed outside of the yard. The timing of the yard ingress and/or egress by the vehicle consists may be coordinated with movements of the vehicles inside the yard, such as to meet a target departure time for the vehicles in the consists, according to an earliest arrival time of the consists at the yard, or the like.

In at least one embodiment, the yard planner system and method may visualize and track work status, progress, and expected completion times of planned vehicle processing activities in a vehicle yard. The system and method may visualize and manage planning exceptions in a yard operating plan, such as missed connections for a vehicle, early and/or late arrivals and/or departures of the consists, insufficient resources to complete one or more vehicle processing operations (for example, insufficient road power, insufficient crews, and/or insufficient switch engines), or the like.

In at least one embodiment, a yard planner system or method may perform the following operations: receiving inbound data for one or more inbound vehicle consists that are scheduled to travel to a vehicle yard, monitoring processing constraints of the vehicle yard on processing the vehicles from the one or more inbound vehicle consists, through the vehicle yard, and out of the vehicle yard, and automatically generating a yard plan that includes one or more scheduled sequences of vehicle processing operations to perform on the respective vehicles in order to process the vehicles from the one or more inbound vehicle consists, through the vehicle yard, and out of the vehicle yard. The inbound data can include connection goals for respective vehicles in the one or more inbound vehicle consists. The connection goals may represent at least one of outbound vehicle consists in which the respective vehicles are to be included when the outbound vehicle consists leave the vehicle yard. The inbound data can include processing operations to be performed on the vehicles in the vehicle yard.

Certain embodiments of the present disclosure provide a method that may include visually displaying, on a display device, scheduled processing operations for plural different vehicles in a vehicle yard. The scheduled processing operations used to receive inbound consists that include the vehicles into the vehicle yard, process the vehicles through the vehicle yard, and assemble the vehicles into outbound consists for departing from the vehicle yard. The scheduled processing operations are displayed so that a user of the display device can view scheduled locations of the vehicles in the vehicle yard, scheduled movements of the vehicles in the vehicle yard, availabilities of different routes in the vehicle yard for performing the processing operations, and/or times at which the scheduled processing operations are to occur.

In at least one embodiment, a system includes a yard workstation configured to visually display, on a display device, scheduled processing operations for plural different vehicles in a vehicle yard, the scheduled processing operations used to receive inbound consists that include the vehicles into the vehicle yard, process the vehicles through the vehicle yard, and assemble the vehicles into outbound consists for departing from the vehicle yard. The scheduled processing operations are displayed so that a user of the display device can view scheduled locations of the vehicles in the vehicle yard, scheduled movements of the vehicles in the vehicle yard, availabilities of different routes in the vehicle yard for performing the processing operations, and/or times at which the scheduled processing operations are to occur.

In at least one embodiment, the scheduled processing operations are displayed on the display device so that two or more of the scheduled locations of the vehicles in the vehicle yard, the scheduled movements of the vehicles in the vehicle yard, the availabilities of different routes in the vehicle yard for performing the processing operations, or the times at which the scheduled processing operations are to occur are concurrently displayed.

In at least one embodiment, the different routes in the vehicle yard are displayed as lines arranged in groups according to designated uses of the routes.

In at least one embodiment, the different routes in the vehicle yard are displayed as route lines oriented parallel to a time bar displayed on the display device. The time bar represents different scheduled times on the display device.

In at least one embodiment, the scheduled processing operations are displayed on the display device with processing lines that cross one or more of the route lines to indicate an origin route on which a processing operation begins for a block of one or more vehicles and to indicate a destination route on which the same processing operation ends for the same block of the one or more vehicles.

In at least one embodiment, the scheduled processing operations are displayed on the display device with timing lines oriented parallel to the time bar. The timing lines have lengths that extend along the time bar to represent at least one or more of scheduled times at which the scheduled processing operations are to occur or scheduled durations of the scheduled processing operations.

In at least one embodiment, the scheduled processing operations are displayed on the display device with at least one of origin symbols or destination symbols. The origin symbols are displayed on the route lines associated with the routes on which the respective scheduled processing operations are scheduled to begin. The destination symbols are displayed on the route lines associated with the routes on which the respective scheduled processing operations are scheduled to end.

As noted, embodiments relate to systems that include a vehicle yard planner system configured to form an initial yard plan based on received yard data, and that is configured to update the initial yard plan to form an updated yard plan based on changing yard data over time. The system may be further configured for vehicle control in the vehicle yard to be based on the initial yard plan and the updated yard plan. For example, movement of vehicles in the vehicle yard may be automatically controlled based on the initial yard plan and the updated yard plan. Automatic control may include communicating the initial yard plan and the updated yard plan to the vehicles, which are configured to move responsively to the initial yard plan and the updated yard plan. Automatic control may also include automatic control of switches (or other machines) in the yard, to route vehicles to specific routes, locations, etc. as the vehicles move through the yard under self-power or gravity/hump. As another example, movement of vehicles in the vehicle yard may be manually controlled based on the initial yard plan and the updated yard plan.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended clauses, along with the full scope of equivalents to which such clauses are entitled. In the appended clauses, the terms “including” and “in which” are used as the plain-English equivalents of the respective terms “comprising” and “wherein.” Moreover, in the following clauses, the terms “first,” “second,” and “third,” etc. are used merely as labels, and are not intended to impose numerical requirements on their objects. Further, the limitations of the following clauses are not written in means-plus-function format and are not intended to be interpreted based on 35 U.S.C. §112(f), unless and until such clause limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the clauses, and may include other examples that occur to those of ordinary skill in the art. Such other examples are intended to be within the scope of the clauses if they have structural elements that do not differ from the literal language of the clauses, or if they include equivalent structural elements with insubstantial differences from the literal languages of the clauses.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

The term “route” is used to denote a track or sequence of tracks in a rail yard, but need not be construed in this interpretation, as in other applications where a route can be interpreted as a road bed, or a sequence of similar paths.

1. A system comprising:
a vehicle yard planner system configured to receive yard data from a plurality of workstations and a plurality of sensors within a vehicle yard, wherein the yard data includes information regarding movement of vehicles and resources in relation to the vehicle yard, wherein the vehicle yard planner system is configured to form an initial yard plan based on the yard data, and wherein the vehicle yard planner system is configured to monitor the yard data over time and update the initial yard plan to form an updated yard plan based on changing yard data over time.

2. The system of claim 1, wherein the initial yard plan includes one or more initial schedules for moving the vehicles through the vehicle yard, and wherein the updated yard plan includes one or more updated schedules for moving the vehicles in relation to the vehicle yard.

3. The system of claim 1, wherein the vehicle yard planner system is configured to monitor the resources to determine availabilities of the resources and constraints on processing the vehicles.

4. The system of claim 1, wherein the yard data includes yard state information that comprises one or more of where the vehicles currently are located in relation to the vehicle yard, where the vehicles are expected to be located in the vehicle yard at a future time, what operations are being performed on the vehicles, or what resources are being expended or used to perform the operations on the vehicles.

5. The system of claim 1, wherein the yard data includes yard goal information that comprises when and where the vehicles are to be positioned when the vehicles exit the vehicle yard.

6. The system of claim 1, wherein the yard data includes yard goal information that comprises vehicle connection goals that include designated tasks that are to be performed on the vehicles, wherein the tasks include cleaning, repair, maintenance, refueling, changing crew, inspecting, unloading of cargo, and loading of cargo while the vehicles are in the vehicle yard.

7. The system of claim 1, wherein the yard data includes performance information that indicates the efficiency of the vehicles moving into and through the vehicle yard.

8. The system of claim 1, wherein the yard data includes administrative information that includes a current state of the vehicle yard planner system.

9. The system of claim 1, wherein the vehicle yard planner system includes a monitor system that obtains the yard data as input information from the plurality of workstations and the plurality of sensors within the vehicle yard.

10. The system of claim 9, wherein the plurality of workstations includes one or more handheld or wearable devices, and wherein the plurality of sensors includes one or more of transponders, video cameras, presence detectors, or track circuits configured to detect a presence of the vehicles at one or more locations in the vehicle yard.

11. The system of claim 1, wherein the yard information includes vehicle connection goals that designate an outbound vehicle consist that a first vehicle identified with the connection goal is to be included in when the first vehicle leaves the vehicle yard, and wherein the vehicle yard planner system is configured to obtain the vehicle connection goals from a network planner system that creates schedules for the vehicles to travel through a network of routes that connect to the vehicle yard.

12. The system of claim 1, wherein the vehicle yard planner system includes a bandwidth system that is configured to monitor constraints on processing operations that are performed on one or more of the vehicles within the vehicle yard.

13. The system of claim 12, wherein the bandwidth system is configured to track one or more of:
route configurations in the vehicle yard, wherein the route configurations include a layout of routes on which the vehicles travel within the vehicle yard, and capacities of the routes within the vehicle yard;
one or both of vehicle inventories in the vehicle yard, or resource availabilities in the vehicle yard;
route maintenance within the vehicle yard; or
time requirements for the processing operations.

14. The system of claim 1, wherein the vehicle yard planner system includes a generation system that is configured to plan movements of the vehicles through the vehicle yard and processing activities to be performed on the vehicles.

15. The system of claim 1, wherein the initial and updated yard plans include information regarding one or more of:
management of approach or arrival of inbound vehicles subject to capacity of the vehicle yard to receive the inbound vehicles;
assignment of receiving segments of vehicle routes to the inbound vehicles;
one or more schedules of air bleeding and vehicle inspection activities at various locations in the vehicle yard;
one or more schedules of a sequence of vehicles to move to a hump in the yard;
assignment of each the vehicles to a classification route segment where the vehicles are sorted together in blocks for continued movements or operations in the vehicle yard;
one or more schedules of a sequence of the vehicles to pull from classification route segments to departure route segments;
assignment of outbound vehicles to departure segments; or
one or more schedules of outbound inspection operations of the outbound vehicles.

16. The system of claim 1, further comprising the plurality of workstations within the vehicle yard, wherein each of the one or more workstations is in communication with the vehicle yard planner system, each of the one or more workstations comprises a tracking system that is configured to receive sensor data from yard sensors within the vehicle yard, wherein the tracking system is configured to determine one or more of: a location at least one of the vehicles within the yard through the sensor data, a processing status of processing operations performed on the at least one of the vehicles, or a state of at least one route segment within the vehicle yard.

17. The system of claim of claim 16, wherein one or both of the vehicle yard planner system or the plurality of workstations includes a display device that is configured to show a visual presentation of the vehicle yard, wherein the visual presentation includes:
a time bar that represents current and future times;
route lines for routes that are used to receive inbound vehicles;
processing operation symbols that denote processing operations that are one or both of being performed or are scheduled to be performed on the vehicles;
a timing line configured to represent one or both of when or how long one or more of the processing operations is to occur; and
one or more status windows that are configured to indicate current status of the resources, inventory, or processing activity within the vehicle yard.

18. The system of claim 1, wherein the vehicle yard planner system is configured to identify one or more opportunities for track maintenance within one or more idle times between planned activities, and wherein the vehicle yard planner system is configured to reserve one or more yard resources for the one or more opportunities.

19. A method comprising:
receiving yard data at a vehicle yard planner system from a plurality of workstations and a plurality of sensors within a vehicle yard, wherein the yard data includes information regarding movement of vehicles and resources within the vehicle yard,
using the yard planner system to form an initial yard plan based on the yard data;
monitoring the yard data over time with the yard planner system; and
updating the initial yard plan to form an updated yard plan based on changing yard data over time.

20. A system comprising:
a network planner system that is configured to create schedules for vehicles to travel through a network of routes that connect to a vehicle yard;
one or more workstations within the vehicle yard; and
a vehicle yard planner system configured to receive yard data from the one or more workstations and a plurality of sensors within the vehicle yard, wherein the yard data includes information regarding movement of vehicles and resources in relation to the vehicle yard, wherein the vehicle yard planner system is configured to form an initial yard plan based on the yard data, wherein the initial yard plan includes one or more initial schedules for moving the vehicles in relation to the vehicle yard, and wherein the vehicle yard planner system is configured to monitor the yard data over time and update the initial yard plan to form an updated yard plan based on changing yard data over time, wherein the updated yard plan includes one or more updated schedules for moving the vehicles through the vehicle yard, wherein the vehicle yard planer system is configured to monitor the resources to determine availabilities of the resources and constraints on processing the vehicles;
wherein one or both of the vehicle yard planner system or the one or more workstations includes a display device that is configured to show a visual presentation of the vehicle yard.

21. The system of claim 20, wherein the yard data includes:
yard state information that comprises one or more of where the vehicles currently are located in the vehicle yard, where the vehicles are expected to be located in the vehicle yard at a future time, what operations are being performed on the vehicles, or what resources are being expended or used to perform the operations on the vehicles;
yard goal information that comprises when and where the vehicles are to be positioned when the vehicles exit the vehicle yard, wherein the yard goal information includes vehicle connection goals that include designated tasks that are to be performed on the vehicles, wherein the tasks include one or more of cleaning, repair, maintenance, refueling, unloading of cargo, or loading of cargo while the vehicles are in the yard; and
performance information that indicates the efficiency of the vehicles moving into and through the vehicle yard and orderliness of the vehicle yard.

22. The system of claim 20, wherein the visual presentation includes:
a time bar that represents current and future times;
route lines for routes that are used to receive inbound vehicles;
processing operation symbols that denote processing operations that are one or both of being performed or are scheduled to be performed on the vehicles;
a timing line configured to represent one or both of when or how long one or more of the processing operations is to occur; and
one or more status windows that are configured to indicate current status of the resources, inventory, or processing activity within the vehicle yard.
